(19) United States
(12) Patent Application Publication
(10) Pub. No.: US 2010/0271711 A1
(43) Pub. Date: Oct. 28, 2010

(54) OPTICAL POSITION DETECTING APPARATUS AND OPTICAL APPARATUS

(76) Inventors: Hideo YOSHIDA, Saitama-shi (JP); Hisao Ito, Saitama-shi (JP); Kengo Kikuta, Saitama-shi (JP)

Correspondence Address: BIRCH STEWART KOLASCH & BIRCH, PO BOX 747, FALLS CHURCH, VA, 22040-0747, US

(21) Appl. No.: 12/748,797

(22) Filed: Mar. 29, 2010

(30) Foreign Application Priority Data
Apr. 22, 2009 (JP) P2009-104118

(51) Int. Cl. G02B 15/14; G01B 11/14

(52) U.S. Cl. 359/694; 356/614

(57) ABSTRACT

The present apparatus includes: a light emitting portion for emitting a detection-receiving light; a light emitting portion arranged parallel to the light emitting portion for emitting a detection-receiving light; a reflecting plate which is moved relative to the light emitting portions along their parallel arranged direction and also includes an optical pattern where a white area and a black area having a reflectance different from the white area with respect to the detection-receiving lights and are arranged alternately; and a light receiving portion which, according to the light intensities of the detection-receiving lights to be reflected by the reflecting plate, outputs output voltage signals. A controller selects one of the output voltage signals as a position detecting signal and obtains information about the position of a moving lens movable in linking with the reflecting plate.

The present application claims priority from Japanese Patent Application No. 2009-104118 filed on Apr. 22, 2009, the entire content of which is incorporated herein by reference

### BACKGROUND OF INVENTION

1. Field of the Invention

The present invention relates to an optical position detecting apparatus and an optical apparatus including such position detecting apparatus.

2. Description of the Related Art

As a related optical position detecting apparatus, there is known an optical position detecting apparatus which includes an optical encoder pattern, a light emitting element and a light receiving element (for example, see JP-A-2007-147622 and JP-A-2007-64981). An optical position detecting apparatus disclosed in JP-A-2007-147622 is an apparatus which, using a light receiving element or an optical encoder pattern having a complicated shape such as a diamond shape, obtains an output signal having a substantially sine wave to detect the position of a moving member. Also, an optical position detecting apparatus disclosed in JP-A-2007-64981 includes: an optical scale containing an index pattern expressing the movement start point of a moving member or the movement end point thereof, and alternately arranged areas differing in transmittance or reflectance from each other; a light emitting element; and, multiple light receiving elements. This apparatus logically combines together multiple output signals respectively obtained from the multiple light receiving elements to detect the positions of the start and end points of the moving range of the moving member as well as the positions thereof within the moving range thereof.

However, in the optical position detecting apparatus disclosed in JP-A-2007-147622, to obtain an output signal having a substantially sine wave, there is necessary a light receiving element or an optical encoder pattern which has a complicated shape such as a diamond shape. This may raise a fear that the production process of the apparatus may be complicated or the production cost thereof may be increased. Also, in the optical position detecting apparatus disclosed in JP-A-2007-64981, since an output signal to be used for position detection has a rectangular wave, to enhance the resolving power thereof, it is necessary to narrow the respective widths of the optical encoder pattern and light receiving portion. This may raise a fear that the production cost of the apparatus may be increased.

### SUMMARY OF INVENTION

The present invention aims at solving the technological problems found in the above-mentioned related apparatus. Thus, it is an object of the invention to provide an optical position detecting apparatus and an optical apparatus which may obtain highly accurate position information using a simple structure.
[1] According to an aspect of the invention, an optical position detecting apparatus includes: a first light emitting portion which emits a first detection-receiving light; a second light emitting portion which is arranged parallel to the first light emitting portion, and which emits a second detection-receiving light; an optical scale which is movable relative to the first and second light emitting portions along a parallel arranging direction of the first and second light emitting portions, the optical scale including an optical pattern containing first and second areas disposed alternately, the second area having different transmittance or reflectance from the first area with respect to the first and second detection-receiving lights; a light receiving portion which outputs a first output signal according to a light intensity of the first detection-receiving light transmitted through the optical scale or a light intensity of the first detection-receiving light reflected by the optical scale, and which outputs a second output signal according to a light intensity of the second detection-receiving light transmitted through the optical scale or a light intensity of the second detection-receiving light reflected by the optical scale; a signal selecting unit, according to a magnitude of one of the first and second output signals, which selects one of the first and second output signals as a position detecting signal; and, a position information obtaining unit, according to the position detecting signal, which obtains position information of a moving member which works with the optical scale.

In an optical position detecting apparatus according to the invention, since it includes a first light emitting portion and a second light emitting portion arranged parallel to the first light emitting portion, detection-receiving lights may be respectively emitted to an optical scale movable relative to the first and second light emitting portions in their parallel arranged direction in such a manner that the radiating positions of the detection-receiving lights into the periodical optical pattern may be different from each other. Owing to this, the light receiving portion may obtain, for example, two periodical output signals with a phase difference between them. And, since the signal selecting unit, according to the magnitudes (signal values) of the two output signals, may select one of the two output signals as a position detecting signal, an output signal having a large variation in the signal value thereof with respect to a variation in the position of the moving member (with respect to the movement of the moving member) may be selected at every detection position as a position detecting signal which may indicate the detection position. In this manner, use of the two output signals with a phase difference between them makes it possible to obtain a position detecting signal having a large variation in the signal value thereof with respect to the movement of the moving member without delicately working the light emitting portions, optical pattern and light receiving portion. This makes it possible to obtain highly accurate position information with a simple structure.
[2] In the optical position detecting apparatus of [1], a distance between the first and second light emitting portions as well as a pattern width made of the first area and a pattern width made of the second area respectively in the parallel arranged direction are set such that a phase difference between the first and second output signals provides 90 degrees.

According to this structure, within the position detecting area, such waveform portion of one output signal as having a small variation in the signal value thereof with respect to the movement of the moving member and such waveform portion of the output signal as having a large variation in the signal value thereof with respect to the movement of the moving member may be properly superimposed on top of each other. Therefore, at every detecting position within the position detecting area, there may be obtained an output signal the signal value of which varies greatly with respect to the movement of the moving member. This makes it possible to obtain highly accurate position information.
[3] In the optical position detecting apparatus of [1], when the magnitude of the first output signal is equal to or larger than a first given value and is equal to or smaller than a second given value larger than the first given value, the signal selecting unit selects the first output signal as the position detecting signal, and when the magnitude of the first output signal is smaller than the first given value or is larger than the second given value, the signal selecting unit selects the second output signal as the position detecting signal.

According to this structure, for example, signal values, which respectively indicate the points where the periodical waveforms of the output signals each having a constant amplitude start to be gentle, are used as first and second given values respectively and, using the relationship between the magnitudes of the output signals and the magnitudes of the first and second given values, an output signal having a large variation in the signal value thereof with respect to the movement of the moving member may be selected as a position detecting signal. This makes it possible to obtain highly accurate position information.
[4] In the optical position detecting apparatus of [1], the signal selecting unit regards an absolute value of a difference between a center value of an amplitude of a waveform of the first output signal and the magnitude of the first output signal as a first check value, and regards an absolute value of a difference between a center value of an amplitude of a waveform of the second output signal and the magnitude of the second output signal as a second check value, and wherein when the first check value is equal to or smaller than the second check value, the signal selecting unit selects the first output signal as the position detecting signal, and when the magnitude of the first check value is larger than the second check value, the signal selecting unit selects the second output signal as the position detecting signal.

According to this structure, for example, even when a phase difference between the first and second output signals is not 90 degrees, there may be obtained highly accurate position information.

Also, the first and second light emitting portions may be structured in such a manner that they may emit the first and second detection-receiving lights alternately. Due to use of this structure, the lights, which are emitted from the first and second light emitting portions and are used as the lights to be detected (detection-receiving lights), may be received by a single light receiving portion.

Further, an optical apparatus according to the invention is structured such that it includes the above-mentioned optical position detecting apparatus. According to this optical apparatus, owing to provision of the above optical position detecting apparatus, information about the position of an optical member may be obtained highly accurately using a simple structure.

According to the invention, there may be obtained highly accurate position information using a simple structure.

### BRIEF DESCRIPTION OF THE DRAWINGS

FIG. 1 a general view of an image pickup apparatus according an embodiment of the invention;

FIG. 2 is a section view of the image pickup apparatus according to the embodiment of the invention;

FIG. 3 is a section view of a driven member, taken along the arrow line III-III shown in FIG. 2;

FIG. 4 is a circuit diagram of an actuator driving circuit used in the image pickup apparatus according to the embodiment of the invention;

FIGS. 5A and 5B are waveform diagrams of a driving signal to be input into a piezoelectric element shown in FIG. 2;

FIG. 6 is a typical view of an optical position detecting apparatus according to the embodiment of the invention;

FIGS. 7A-7C are general views to explain the structure and output voltage signal of the optical position detecting apparatus according to the embodiment of the invention;

FIG. 8 is a circuit diagram of a photo reflector driving circuit of the optical position detecting apparatus according to the embodiment of the invention;

FIGS. 9A-9C are views of driving signals used in the optical position detecting apparatus according to the embodiment of the invention;

FIG. 10 is a general view to explain the output voltage signal of the optical position detecting apparatus according to the embodiment of the invention;

FIGS. 11A and 11B are general views to explain the A/D conversion that is carried out by the image pickup apparatus according to the invention;

FIGS. 12A and 12B are views of voltage signals before and after the switching operation of an optical position detecting apparatus according to the embodiment of the invention;

FIGS. 13A and 13B are views of voltage signals before and after the adjusting operation of the optical position detecting apparatus according to the embodiment of the invention;

FIG. 14 is a flow chart of the operation of the image pickup apparatus according to the embodiment of the invention;

FIGS. 15A and 15B are general views to explain the amount of a variation in the signal value of the output voltage signal;

FIGS. 16A-16C are views of voltage signals before and after the switching operation of an optical position detecting apparatus according to a second embodiment of the invention; and

FIGS. 17A-17B are views of voltage signals before and after the switching operation of an optical position detecting apparatus according to the first embodiment of the invention.

### DESCRIPTION OF EXEMPLARY EMBODIMENTS

Now, description will be given below of an embodiment according to the invention with reference to the accompanying drawings. Here, in the respective drawings, the same or equivalent parts are given the same designations and thus the duplicate description thereof will be omitted.

### First Embodiment

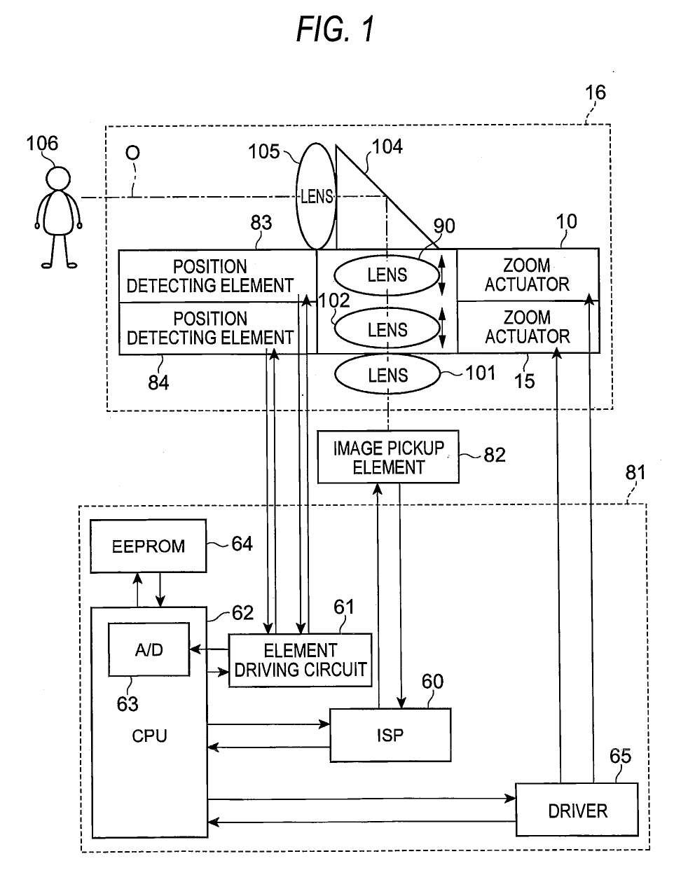

An image pickup apparatus (optical apparatus) according to the present embodiment is an apparatus which, for example, may be suitably employed as an image pickup apparatus including a bending optical system. Firstly, description will be given below of the summary of the image pickup apparatus according to the present embodiment. FIG. 1 is a general view to show an image pickup system used in the image pickup apparatus according to the present embodiment.

The image pickup apparatus shown in FIG. 1 uses a bending optical system for bending an optical axis O, and also includes a zoom lens unit portion 16, an image pickup element 82 and a controller (signal selecting unit, position information obtaining unit) 81. The zoom lens unit portion 16 has the image pickup optical system of the image pickup apparatus; and, it also includes a fixed lens 105, a prism 104, moving lenses (moving member, optical member) 90, 102, and a fixed lens 101. Also, the controller 81 is used to control the whole of the image pickup apparatus and includes, for example, a CPU (Central Processing Unit) 62, an ISP (Image Signal Processing Unit) 60, an element driving circuit 61, an EEPROM (Electrically Erasable PROM) 64, and a driver 65.

To the moving lenses 90 and 102, there are connected an actuator (driving source) 10 for zooming and an actuator (driving source) 15 for auto focusing, respectively. With the driving operations of the respective actuators 10 and 15, the moving lenses 90 and 102 are moved along the optical axis O to thereby realize a zooming function and an auto-focusing function. The actuators 10 and 15 are respectively connected to the driver 65, whereby the driving control of the actuators 10 and 15 may be carried out by the driver 65 and CPU 62.

The image pickup element 82 is disposed on the optical axis O and is used to convert an image, which is formed by the image pickup system of the zoom lens unit portion 16, to an electric signal. The image pickup element 82 is made of, for example, a CCD (Charge Coupled Device image sensor) and is connected to the ISP 60.

The image of an object 106 input to the zoom lens unit portion 16 is bent through the fixed lens 105 and prism 104 and is allowed to arrive through the moving lenses 90, 102 and fixed lens 101 at the image pickup element 82; and, it is then processed as an image by the ISP 60 and CPU 62.

Here, the positions of the moving lenses 90 and 102 are respectively detected by position detecting elements (optical position detecting elements) 83 and 84 which are included in the zoom lens unit portion 16. That is, the respective position detecting elements 83 and 84 function as lens position detecting unit. The position detecting elements 83 and 84 are respectively connected to the element driving circuit 61, whereby they may be controlled and driven by the element driving circuit 61. Light intensities, which are detected by the respective position detecting elements 83 and 84, are output as output signals through the element driving circuit 61 and are A/D converted by an A/D converting portion 63 included in the CPU 62.

According to the thus A/D converted output signals and information or the like stored into the EEPROM 64, the CPU 62 and driver 65 control and drive the respective actuators 10 and 15 in a feedback manner. Here, in the EEPROM 64, for example, there are stored output signals with respect to the zoom position and AF position that have been obtained through measurements made in the adjusting operation. In this manner, the lens driving unit of the image pickup apparatus is structured such that it may be operated in linking with the position detecting unit.

Next, description will be given below in detail of the structures of the above-mentioned respective composing portions. Here, in the following description, for easy understanding of the structures, as a typical example, the structure of the structure of the moving lens 90 will be described in detail.

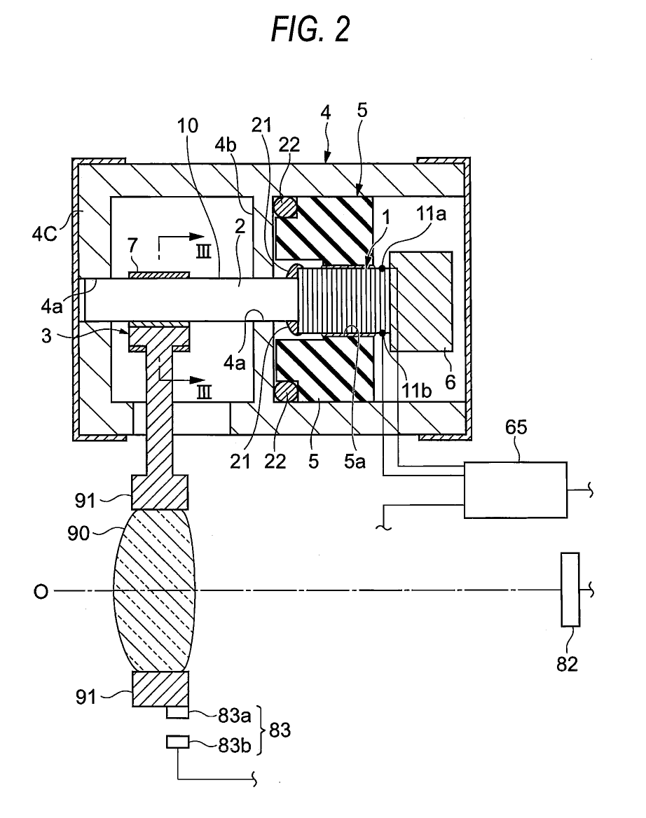

Firstly, description will be given in detail of the lens driving unit of the image pickup apparatus. FIG. 2 is a section view of a driving apparatus for driving the moving lens 90. The driving apparatus shown in FIG. 2 includes an actuator 10 which is made of a piezoelectric element 1 and a driving shaft 2 mounted on the piezoelectric element 1. In this driving apparatus, according to the expansion and contraction of the piezoelectric element 1, the driving shaft 2 is moved back and forth, whereby a driven member (moving member) 3 frictionally engaged with the driving shaft 2 may be moved along the driving shaft 2.

The piezoelectric element 1 is an electromechanical conversion element which may be expanded and contracted due to the input of a drive signal and, specifically, it may be expanded and contracted in a given direction. The piezoelectric element 1 is connected to the controller 81 and may be expanded and contracted by the driver 65 inputting an electric signal. For example, in the piezoelectric element 1, there are provided two input terminals 11a and 11b. By repetitively increasing and decreasing voltages input to the input terminals 11a and 11b, the piezoelectric element 1 may be expanded and contracted repetitively. Here, as the electromechanical conversion element, other elements than the piezoelectric element 1, for example, an element made of conductive high molecules or a shape memory alloy, may also be used, provided that they may be expanded and contracted due to the input of a driving signal.

The driving shaft 2 is mounted on the piezoelectric element 1 in such a manner that the longitudinal direction thereof extends in the expansion and contract direction of the piezoelectric element 1. For example, one end of the driving shaft 2 is contacted with the piezoelectric element 1 and is bonded thereto using an adhesive agent 21. The driving shaft 2 is made of a long member, for example, a cylindrical member. The driving shaft 2 is supported by partition portions 4b and 4b respectively extending inwardly of a fixed frame 4 in such a manner that it may be moved along the longitudinal direction thereof. The partition portions 4b and 4c are made of members which are used to partition the moving area of the driven member 3; and also, they function as support members for supporting the driving shaft 2. The fixed frame 4 functions as a box member which stores and assembles the piezoelectric element 1, driving shaft 2, driven member 3 and the like therein.

The driving shaft 2 may made of a member which is light and high in rigidity. Here, the shape of the driving shaft 2 is not limited to the cylindrical shape but may also be a prismatic shape.

In the partition portions 4b and 4c, there are respectively formed penetration holes 4a through which the driving shaft 2 may be penetrated. The partition portion 4b supports the neighborhood of the mounting portion of the driving shaft 2 where the driving shaft 2 is mounted on the piezoelectric element 1, that is, the base end portion of the driving shaft 2. The partition portion 4c supports the leading end portion of the driving shaft 2. When the driving shaft 2 is mounted onto the piezoelectric element 1, the driving shaft 2 is allowed to move back and forth along the longitudinal direction thereof according to the repetitive expanding and contracting operations of the piezoelectric element 1.

Here, in FIG. 2, there is shown a case in which the driving shaft 2 is supported in the two portions thereof, that is, on the leading end and base end sides thereof by the partition portions 4b and 4c. However, the driving shaft 2 may also be supported in one portion, that is, on the leading end or base end side thereof. For example, when the penetration hole 4a of the partition portion 4b is formed larger than the outside diameter of the driving shaft 2, the driving shaft 2 is supported only in the leading end portion thereof by the partition portion 4c. Also, when the penetration hole 4a of the partition portion 4c is formed larger than the outside diameter of the driving shaft 2, the driving shaft 2 is supported only in the base end portion thereof by the partition portion 4b.

Also, in FIG. 2, there is shown a case in which the partition portions 4b and 4c for supporting the driving shaft 2 are formed integrally with the fixed frame 4. However, the partition portions 4b and 4c may also be formed separately from the fixed frame 4 and may be then mounted onto the fixed frame 4. Even when the partition portions 4b and 4c are formed separately from the fixed frame 4, there may be provided a similar effect to the case where they are formed integrally with the fixed frame 4. The driven member 3 is movably mounted on the driving shaft 2.

The driven member 3 is mounted in such a manner that it is frictionally engaged with the driving shaft 2 and may be moved in the longitudinal direction of the driving shaft 2. For example, the driven member 3 is pressure contacted with the driving shaft 2 by a plate spring 7 and is thereby engaged with the driving shaft 2 with a given coefficient of friction; and, the driven member 3 is mounted in such a manner that, when it is pressed against the driving shaft 2 with a given pressing force, due to the movement thereof, it may generate a given level of frictional force. Since the driving shaft 2 moves in such a manner that it goes beyond the thus generated frictional force, the driven member 3 may maintain its position due to the inertia thereof and the driving shaft 2 moves relative to such driven member 3.

The piezoelectric element 1 is mounted on the fixed frame 4 by a support member 5. The support member 5 is structured such that it supports and mounts the piezoelectric element 1 from the lateral sides thereof with respect to the expansion and contraction direction thereof; and, the support member 5 is interposed between the piezoelectric element 1 and fixed frame 4. In this case, the piezoelectric element 1 may be supported by the support member 5 from a direction perpendicular to the expansion and contraction direction of the piezoelectric element 1. The support member 5 functions as a mounting member which supports the piezoelectric element 1 from the lateral sides thereof and mounts it onto the fixed frame 4.

In this manner, the actuator 10 is supported by the support member 5 from the lateral sides thereof with respect to the expansion and contraction direction of the piezoelectric element 1, while the two ends of the actuator 10 are free ends which are movable in the expansion and contraction direction of the piezoelectric element 1. This provides a structure in which, even when the actuator 10 is driven, vibrations generated due to the expansion and contraction of the piezoelectric element 1 are hard to be transmitted toward the fixed frame 4. Therefore, it is effective to set the driving signal of the actuator 10 in linking with the resonance frequency of the actuator 10 itself.

The support member 5 is made of elastic material such as silicone resin having a given elastic modulus or larger. The support member 5 is structured such that it includes an insertion hole 5a through which the piezoelectric element 1 may be inserted; and, the support member 5 is assembled to the fixed frame 4 in a state where the piezoelectric element 1 has been inserted through the insertion hole 5a. The fixation of the support member 5 to the fixed frame 1 is carried out by bonding the former to the latter using an adhesive agent 22. And, the fixation between the support member 5 and piezoelectric element 1 is also carried out using an adhesive agent. Since the support member 5 is made of the elastic material, the piezoelectric element 1 may be supported in such a manner that it may be moved in the expansion and contraction direction thereof. In FIG. 2, although the support member 5 is shown as 5, 5 on both sides of the piezoelectric element 1, such double illustration is caused by taking the support member 5 along the ring-shaped section thereof.

Here, the fixation of the support member 5 to the fixed frame 4 and to the piezoelectric element 1 may also be carried out in such a manner that the support member 5 is pressure inserted between the fixed frame 4 and piezoelectric element 1 and is then pressed against them. For example, the support member 5 is made of elastic material; and, it is formed to have a larger size than the distance between the fixed frame 4 and piezoelectric element 1 and is interposed between them by pressure insertion. As a result of this, the support member 5 is interposed between them in such a manner that it is in close contact with them. In this case, the piezoelectric element 1 is pressed by the support member 5 from the two sides thereof respectively extending perpendicularly to the expansion and contraction direction thereof. As a result of this, the piezoelectric element 1 may be supported.

Also, although description has been given here of a case in which the support member 5 is made of silicone resin, the support member 5 may also be made of a spring member. For example, a spring member may be interposed between the fixed frame 4 and piezoelectric element 1 and the piezoelectric element 1 may be supported on the fixed frame 4 by the spring member.

On the driven member 3, there is mounted the moving lens 90 through a lens frame 91. The moving lens 90 constitutes the image pickup optical system of a camera and may be driven by the driving apparatus. The moving lens 90 is structured such that it is formed integrally with the driven member 3 and may be moved together with the driven member 3. On the optical axis O of the moving lens 90, as described above using FIG. 1, there are fixed the fixed lens and the like, thereby constituting the image pickup optical system of the camera. As the moving lens 90, there is used, for example, a zoom lens.

On the end portion of the piezoelectric element 1, there is mounted a weight member 6. The weight member 6 is a member which is used to transmit the expansion and contraction force of the piezoelectric element 1 toward the driving shaft 2. The weight member 6 is mounted on the opposite end portion of the piezoelectric element 1 to the end portion thereof where the driving shaft 2 is mounted.

The weight member 6 is a part which constitutes a portion of the actuator 10. As the weight member 6, there is used a member which is heavier than the driving shaft 2.

The weight member 6 is made of the material that has a smaller Young's modulus than the piezoelectric element 1 and driving shaft 2. Here, as an adhesive agent for fixing together the weight member 6 and piezoelectric element 1, there may be used an elastic adhesive agent.

Also, the weight member 6 is set in such a manner that it is not supported by nor fixed to the fixed frame 4. That is, the weight member 6 is mounted on the free end of the piezoelectric element 1 but is not directly supported nor fixed to the fixed frame 4; and also, it is not supported or fixed in such a manner that the movement thereof with respect to the fixed frame 4 is restricted through an adhesive agent or a resin member.

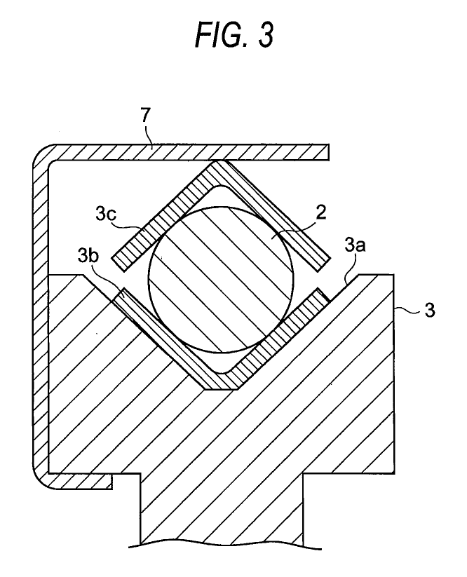

FIG. 3 is a section view of the frictionally engaging portion of the driven member 3, taken along the line shown in FIG. 2. As shown in FIG. 3, the driven member 3 is mounted on the driving member 2 by pressing the driving shaft 2 using the plate spring 7. For example, in the driven member 3, there is formed a V-shaped groove 3a which is used to position the driving shaft 2. In the groove 3a, there is disposed a slide plate 3b having a V-shaped section; and, the driving shaft 2 is pressed against the driven member 3 through the slide plate 3b.

Also, between the plate spring 7 and driven member 3, there is interposed a slide plate 3c having a V-shaped section, and the plate spring 7 presses the driven member 3 through the slide plate 3c. For this purpose, the two slide plates 3b and 3c are arranged in such a manner that their respective recessed portions face each other, while the slide plates 3b and 3c are disposed with the driving shaft 2 between them. When the driving shaft 2 is stored into the V-shaped groove 3a, the driving member 3 may be mounted onto the driving shaft 2 stably.

As the plate spring 7, there is used, for example, a plate spring having an L-shaped section. When the one side of the plate spring 7 is engaged with the driven member 3 and the other side of the plate spring 7 is disposed at the opposite position of the groove 3a, the driving shaft 2 to be stored into the groove 3a may be held into between the plate spring 7 and driven member 3 by the other side of the plate spring 7.

In this manner, since the driven member 3 is mounted such that it is pressed toward the driving shaft 2 by the plate spring 7 with a given force, the driven member 3 may be frictionally engaged with the driving shaft 2. That is, the driven member 3 is mounted such that it is pressed against the driving shaft 2 with a given pressing force and, when it moves, may generate a given frictional force.

Also, since the driving shaft 2 is held by and between the two slide plates 3b and 3c respectively having a V-shaped section, the driven member 3 is line contacted with the driving shaft 2 in the multiple portions thereof, whereby the driven member 3 may be frictionally engaged with the driving shaft 2 stably. Also, since the driven member 3 is engaged with the driving shaft 2 while it is line contacted with the driving shaft 2 in the multiple portion thereof, there may be provided the engaged state that is substantially similar to the engaged state where the driven member 3 is engaged with the driving shaft 2 in a surface contact manner. That is, there may be realized stable frictional engagement.

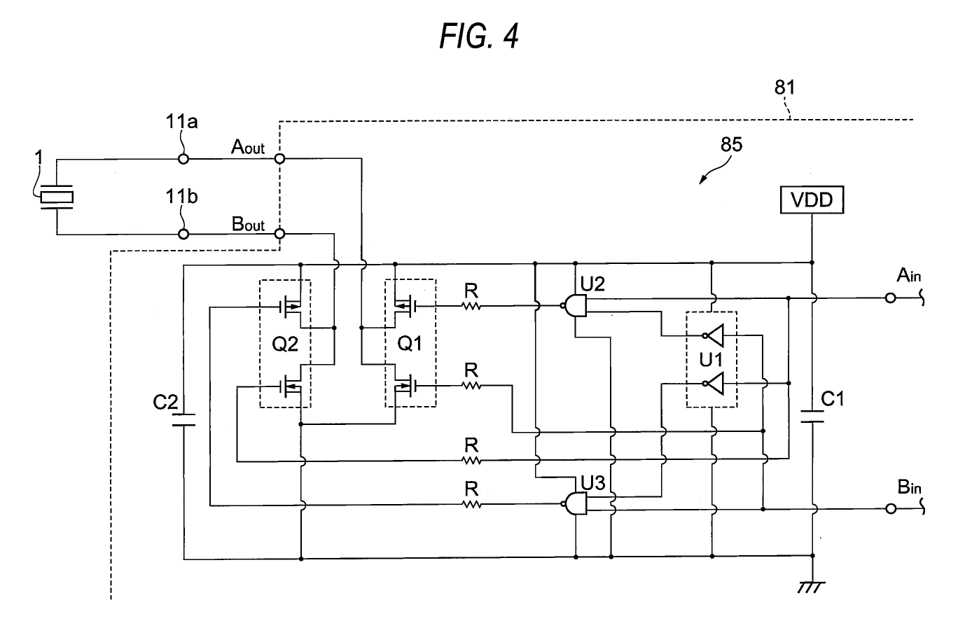

Next, description will be given below in detail of the driver 65 which controls the operation of the above-mentioned actuator 10. The driver 65 includes a drive circuit which may operate the piezoelectric element 1. FIG. 4 is a circuit diagram of a drive circuit 85 which is used to operate the piezoelectric circuit 1. The drive circuit 85 functions as a drive circuit for the piezoelectric element 1 and outputs an electric signal for driving to the piezoelectric element 1. The drive circuit 85 inputs therein a control signal from the CPU 62, voltage amplifies or current amplifies the thus input control signal and outputs the thus amplified control signal as an electric signal for driving the piezoelectric element 1. The drive circuit 85 may be structured such that, for example, the input stage thereof includes logical circuits U1˜U3 and the output stage thereof includes field effect transistors (FETs) Q1 and Q2. The transistors Q1 and Q2 are respectively structured such that, as the output signals thereof, they may output a Hi output (high potential output), a Lo output (low potential output), and an off output (off output, open output). Here, the drive circuit shown in FIG. 4 is an example of a circuit which is used to operate the piezoelectric element 1. That is, the piezoelectric element 1 may also be operated using other types of circuit than the shown drive circuit.

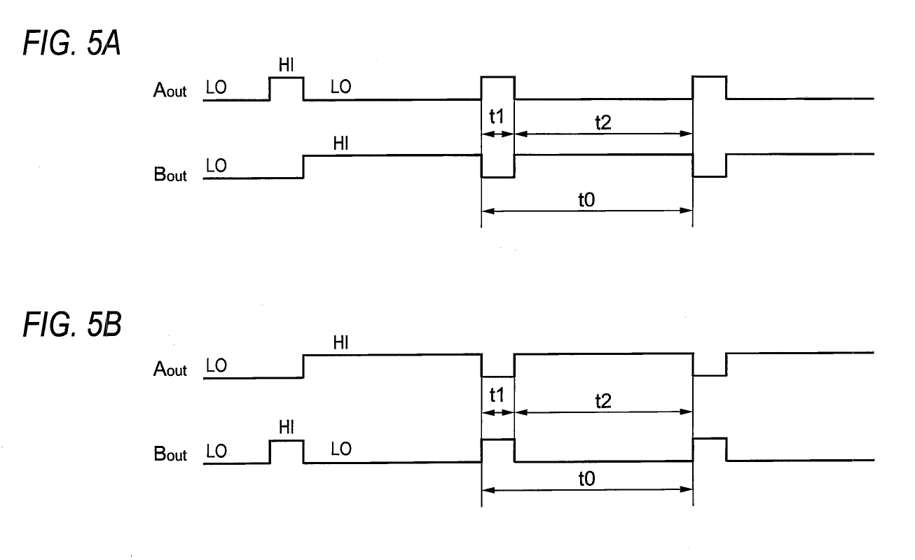

FIG. 5 shows an example of drive signals which are output from the drive circuit 85. Specifically, FIG. 5A shows a drive signal to be input to the piezoelectric element 1 when the driven member 3 is moved in a direction (in FIG. 2, in the right direction) to approach the piezoelectric element 1; and, FIG. 5B shows a drive signal to be input to the piezoelectric element 1 when the driven member 3 is moved in a direction (in FIG. 2, in the left direction) to part away the piezoelectric element 1.

In the drive signals shown in FIGS. 5 (A) and 5 (B), an Aout signal is input to one input terminal 11a of the piezoelectric element 1, while a Bout signal is input to the other terminal 11b of the piezoelectric element 1. Thus, a potential difference between the Aout and Bout provides the input voltage of the piezoelectric element 1.

The drive signals shown in FIGS. 5(A) and 5(B) are signals each having a rectangular waveform. However, the waveform of a signal which is actually input to the piezoelectric element 1 is a triangular waveform due to the capacitor component of the piezoelectric element 1. Therefore, unless the high and low duty ratio is 50%, due to the input of a drive signal having a rectangular waveform, the expansion speed and contraction speed of the piezoelectric element 1 may be made to differ from each other, thereby being able to move the driven member 3.

The drive signals shown in FIGS. 5(A) and (B) are pulse signals and also signals when the actuator 10 is driven. Since signals per pulse are input successively to the actuator 10, the actuator 10 is driven continuously (driving state). Here, the signals that are input to the actuator 10 are not limited to the signals shown in FIGS. 5(A) and 5(B) but, instead of the pulse signals, there may also be input a signal having a sawtooth waveform or a signal having a triangular waveform.

On the other hand, a signal when the actuator 10 is not in operation, although not shown, is a signal when the potential difference between the two terminals of the piezoelectric element 1 is zero. Also, the input signal of zero potential difference in the stopping state of the actuator 10 may be a signal having a zero potential difference in the time that is equal to or longer than the cycle time of one pulse in the input signals in the actuator driving time shown in FIGS. 5(A) and 5(B). When such signal is input to the actuator 10, the driving of the actuator 10 is caused to stop (stopping state).

Also, the driver 65 has a function to control the drive circuit 85 and change the waveform of a drive signal to be output to the actuator 10. For example, the driver 65 changes the number of pulses per unit time to thereby change the waveform of the drive signal. Specifically, the driver 65 thins out the pulses or changes the interval between the pulses to thereby change the number of pulses per unit time. Further, when moving the driven member 3, in order to change the number of pulses per unit time, after passage of a period while signals per pulse are successively input, there is set a period when a potential difference between the Aout and Bout signals is zero (or the Aout and Bout signals are open) for a time equal to or longer than the cycle time of one pulse, and the waveform of the drive signal is changed in such a manner that the two periods may appear alternately and repetitively. That is, the waveform of the drive signal is changed in such a manner that the successive pulses (driving instruction) and the signals of a zero potential difference (stopping instruction) are output repetitively and alternately.

Next, description will be given below of the lens position detecting unit of the image pickup apparatus. As shown in FIG. 2, the image pickup apparatus includes an optical type position detecting element 83 serving as the lens position detecting unit. The position detecting element 83 includes a reflecting plate (optical scale) 83a and a photo reflector 83b. The reflecting plate 83a is mounted on the lens frame 91 movable in linking with the driven member 3 and is structured such that it may be moved with respect to the photo reflector 83b. Also, the reflecting plate 83a is disposed such that it faces the photo reflector 84b within the moving area of the moving lens 90.

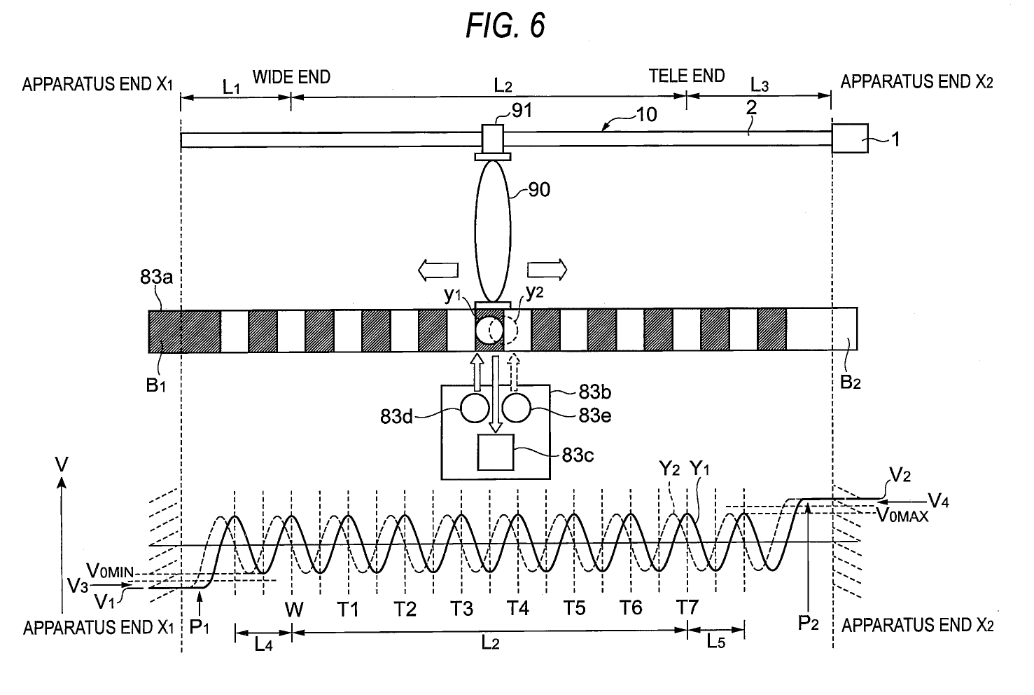

Now, description will be given below in detail of the structures of the reflecting plate 83a and photo reflector 83b with reference to FIG. 6. FIG. 6 is a typical view of the structure of the position detecting apparatus and an output signal corresponding to the position of the moving lens. In FIG. 6, in order to facilitate the understanding of the following description, a great emphasis is placed on the reflecting plate 83a. Also, in FIG. 6, the moving lens 90 is structured such that it is movable within areas L₁˜L₃ extending from the neighborhood of an apparatus end X₁ on the leading end side of the driving shaft 2 to the neighborhood of an apparatus end X₂ on the piezoelectric element 1 side. The “wide end” is a lens position where a focal distance is set shortest, while the “tele end” is a lens position where the focal distance is set longest. An area extending from the “wide end” to the “tele end” provides an image pickup area L₂ where the moving lens 90 is able to form a proper image. The other areas L₁ and L₃ than the image pickup area L₂ are areas where the moving lens 90 is movable but the movable lens 90 is not able to fulfill the function of a zoom lens fully. Also, for easy understanding of the description, the left direction in FIG. 6 is regarded as a “wide end” direction, while the right direction in FIG. 6 is regarded as a “tele end” direction.

As shown in FIG. 6, on such surface of the reflecting plate 83 as faces the photo reflector 83b, there is formed an optical pattern which corresponds to the moving position of the moving lens 90. This optical pattern includes an area (black area) having a small reflectance with respect to emission lights (lights to be detected) y₁, y₂ respectively emitted from the photo reflector 83b and an area (white area) having a larger reflectance than the black area with respect to the emission lights y₁, y₂ from the photo reflector 83b; and, the optical pattern is a white and black pattern (position detecting pattern) where the white and black areas are disposed alternately along the moving direction of the moving lens 90. In both ends of the optical pattern, there are formed origin detecting areas B₁ and B₂ which respectively indicate the ends of the moving area of the moving lens 90. The origin detecting area B₁ is formed such that, for example, it has a smaller reflectance than the black area; and, the origin detecting area B₂ is formed, for example, to have a larger reflectance than the white area. Here, description is given in such a manner that the white and black areas are equal to each other in the pattern width in the moving direction of the moving lens 90. However, the white and black areas may not always be equal in the pattern width. Also, the pattern cycle may be set according to a detection area required.

The photo reflector 83b is disposed on the zoom lens unit portion 16 side shown in FIG. 1 in such a manner that it is opposed to the reflecting plate 83a; and, the photo reflector 83b is disposed such that it may be fixed relative to the reflecting plate 83a. Also, the photo reflector 83b, as shown in FIG. 6, includes light emitting elements (light emitting portions 83d, 83e) for emitting the light, and a light receiving element (light receiving portion 83c) for receiving the light.

Also, the reflecting plate 83a and photo reflector 83b are disposed such that, within the areas L₁˜L₃ where the moving lens 90 is movable, when the moving lens 90 moves to any position, the emission lights (lights to be detected) y₁, y₂ to be emitted from the photo reflector 83b may be radiated onto the optical pattern of the reflecting plate 83a. Also, the reflecting plate 83b and photo reflector 83b are disposed such that, when the moving lens 90 reaches the boundaries of the image pickup area L₂, that is, the “wide end” (position W) and “tele end” (position T7), the center of the radiating area of one of the emission lights y₁, Y₂ may coincide with center of the white or black area of the reflecting plate 83a. Further, the reflecting plate 83a and photo reflector 83b are disposed such that, when the moving lens 90 reaches the moving terminal point thereof (the neighborhood of the apparatus end X₁), the emission lights y₁, y₂ to be emitted from the photo reflector 83b may be radiated only in one of the white area B₁ and black area B₂ respectively existing in the two ends of the optical pattern.

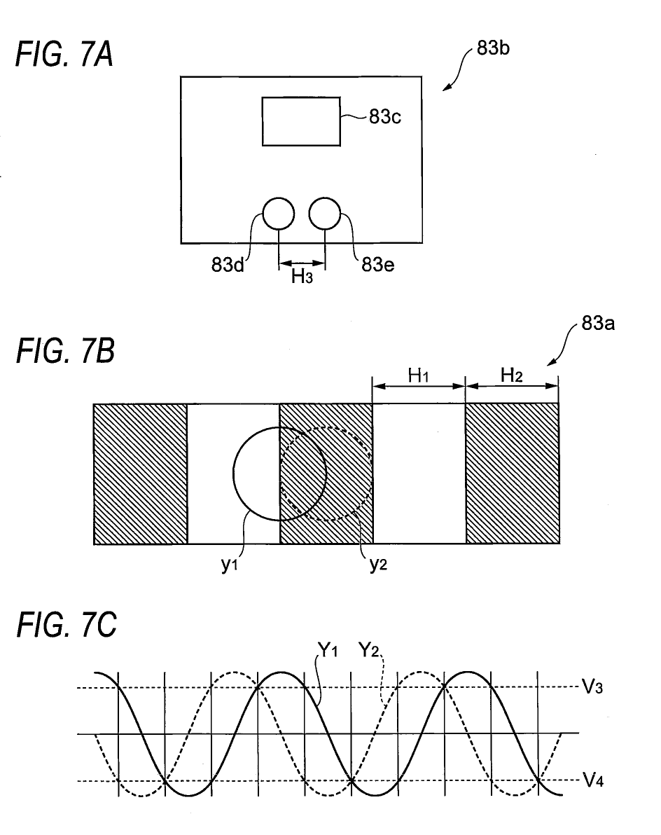

Next, description will be given below of the detailed structure of the photo reflector 83b. FIG. 7(A) shows the detailed structure of the photo reflector 83b, and FIG. 7(B) is a partially enlarged view of an optical pattern disposed opposed to the photo reflector 83b shown in FIG. 7(A). As shown in FIG. 7(A), the light emitting portions 83d and 83e are arranged parallel to each other with a distance H₃ between them. The width of the distance H₃ will be discussed later. And, as shown in FIGS. 7(A) and 7(B), the light emitting portions 83d and 83e are arranged parallel to each other in such a manner that they extend in the same direction as the arranging direction of the white and black patterns. That is, the parallel arranging direction of the light emitting portions 83d and 83e, the arranging direction of the white and black patterns and the moving direction of the moving lens 90 are set all in the same direction.

Also, the light emitting portions 83d and 83e of the photo reflector 83b, for example, are structured to be able to emit the emission lights y₁ and y₂ in which the radiating width of the reflecting plate 83a in the moving direction of the moving lens 90 is substantially equal to the width H₁ of the white area (width H₂ of the black area) of the white and black patterns in the moving direction of the moving lens 90. Here, the light emitting ports of the light emitting portions 83d and 83e are, for example, as shown in FIG. 6, formed in a circular shape; and, by changing the size of the diameter of the light emitting port, the radiating width may be set. Also, the size of the radiating width is a size that satisfies the above condition and may be set in a range where, after the A/D conversion, the amplitude of the output voltage signal may be detected. As the emission lights y₁ and y₂ to be emitted from the light emitting portions 83d and 83e, for example, there is used an infrared light.

Also, the light receiving portion 83c has a function to detect the light receiving amount (light intensity) of a reflected light which is reflected by the reflecting plate 83a. The light receiving port of the light receiving portion 83c is formed, for example, in a rectangular shape.

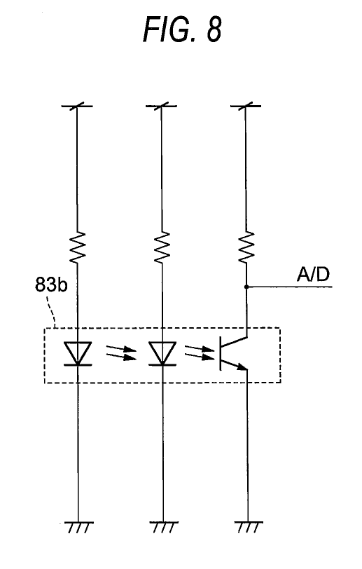

Next, description will be given below of a circuit which is used to operate the photo reflector 83b. The photo reflector 83b, for example, as shown in FIG. 8, receives the reflected versions of the lights emitted from the two light emitting portions in the light receiving portion thereof, and detects the light intensities of the reflected lights as voltage signals (output signals). The thus detected voltage signals are then A/D converted by the A/D converting portion 63 included in the CPU 62. Also, the photo reflector 83b is connected to the element driving circuit 61 shown in FIG. 1 and is thus structured such that, when driven by the element driving circuit 61, the light emitting portions 83d and 83e respectively may emit the emission lights y₁ and y₂ to the reflecting plate 83a at a given timing.

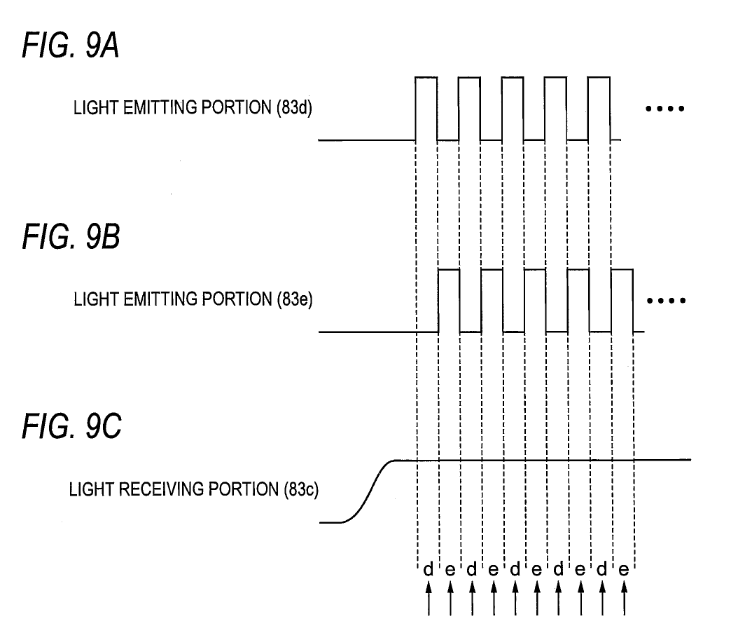

Here, description will be given below of drive signals which are output to the light emitting portions 83d, 83e and light receiving portion 83c by the element driving circuit 61. FIG. 9(A) shows a drive signal to the light emitting portion 83d, FIG. 9(B) shows a drive signal to the light emitting portion 83e, and FIG. 9(C) shows a drive signal to the light receiving portion 83c, respectively. The drive signals of the light emitting portions 83d and 83e are used to drive the light emitting portions 83d and 83e in such a manner that the light emitting portions 83d and 83e do not emit their respective emission lights y₁ and y₂ at the same time.

For example, as shown in FIGS. 9(A) and 9(B), the respective drive signals are set such that they have a duty ratio of 50% and a phase difference of 180 degrees. Due to the drive signals shown in FIGS. 9(A) and 9(B), the light emitting portions 83d and 83e are controlled such that the emission lights y₁ and y₂ may be emitted alternately. Also, due to the drive signal shown in FIG. 9(C), the light receiving portion 83c is driven continuously.

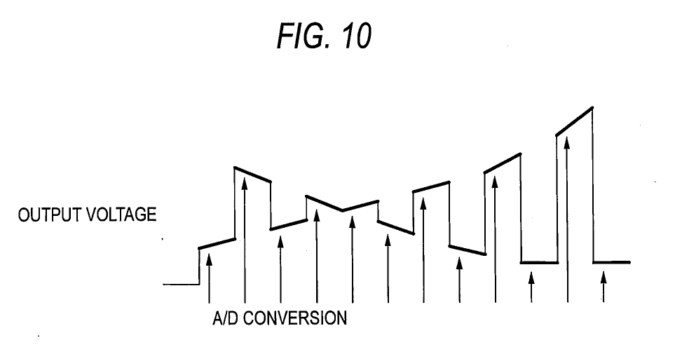

Next, description will be given below of a voltage signal which is output by the light receiving portion 83c. FIG. 7 (C) shows an output voltage signal which is output when the reflecting plate 83a has moved relative to the photo reflector 83b. As shown in FIGS. 7(B) and 7(C), for the emission light y₁ of the light emitting portion 83d, there is detected an output voltage signal Y₁; and, for the emission light y₂ of the light emitting portion 83e, there is detected an output voltage signal Y₂. When the output voltage signals Y₁ and Y₂ shown in FIG. 7(C) are partially enlarged, there is obtained FIG. 10. As shown in FIG. 10, the voltage signals Y₁ and Y₂ to be output from the light receiving portion 83c are output alternately in correspondence to the emission lights y₁ and y₂ that have been output alternately from the light emitting portions 83d and 83e.

The respective output voltage signals Y₁ and Y_{2,} as shown in FIGS. 7(B) and 7(C), vary according to the rate that the white area occupies in the radiating area. For example, as the occupation rate of the white area in the radiating increases, there is increased a reflectance with respect to the emission lights y₁ and y₂ in the radiating area. Owing to this, the respective signal values of the output voltage signals Y₁ and Y₂ increase as the occupation rate of the white area in the radiating area increases. That is, when the center of the white area of the reflecting plate 83a is situated at the center of the radiating area, within the moving area except for the neighborhood of the apparatus ends thereof, the reflectance with respect to the emission light in the radiating area becomes highest; and, in the image pickup area L₂, the signal value of the output voltage signal becomes largest. Oppositely, when the center of the black area of the reflecting plate 83a is situated at the center of the radiating area, within the moving area except for the neighborhood of the apparatus ends thereof, the signal value of the output voltage signal becomes smallest in the image pickup area L₂. Therefore, when the reflecting plate 83a having periodical white and black patterns has moved with respect to the photo reflector 83b, as shown in FIGS. 6 and 7(C), the output voltage signals provide signals which have varied periodically.

Also, as shown in FIGS. 6 and 7(C), the output voltage signals Y₁ and Y₂ provide signals which differ in phase from each other. This phase difference is set according to the distance H₃ between the light emitting portions 83d and 83e as well as the period of the optical pattern (pattern width). Here, when the width H₁ of the white area and the width H₂ of the black area of the optical pattern are already determined, the phase difference between the output voltage signals Y₁ and Y₂ is adjusted by the distance H₃. For example, as shown in FIG. 7(C), the distance H₃ between the light emitting portions 83d and 83e is adjusted in such a manner that the phase difference becomes 90 degrees. More specifically, the distance H₃ between the light emitting portions 83d and 83e is adjusted in such a manner that it becomes half the width H₁ of the white area of the optical pattern or half the width H₂ of the black area of the optical pattern. Here, in the following description, in the output voltage signals Y₁ and Y₂ corresponding to the moving area except for the neighborhood of the apparatus ends (periodical waveform portions), the change points of the signal values where the signal values are increased and decreased due to the movement of the reflecting plate 83a as well as the change points where they are decreased and increased are respectively referred to as extreme values.

Next, description will be given below of the relationship between the position of the moving lens 90 and output voltage signals Y₁, Y². When, within the areas L₁˜L₃ where the moving lens 90 is movable, the moving lens 90 moves in the “wide end” direction (in FIG. 6, in the left direction) or in the “tele end” direction (in FIG. 6, in the right direction), according to such movement of the moving lens 90, the reflecting plate 83a is moved relative to the photo reflector 83b, thereby changing the area of the reflecting plate 83a that is radiated by the photo reflector 83b. That is, the distribution of the white and black areas contained in the radiating area (radiating width) is changed according to the moving positions of the reflecting plate 83a. Owing to this, the photo reflector 83b outputs voltage signals each having a sine wave according to the moving positions of the moving lens 90, as shown in FIG. 6.

On the other hand, when the moving lens 90 moves to the neighborhood of the apparatus end X₁, as shown in FIG. 6, the photo reflector 83b outputs a voltage V₁ smaller than the lower limit value V_{0MIN} and a voltage V₂ larger than the upper limit value V_{0MAX} in the amplitude of an output voltage signal of a sine wave in areas L₄, L₂ and L₅.

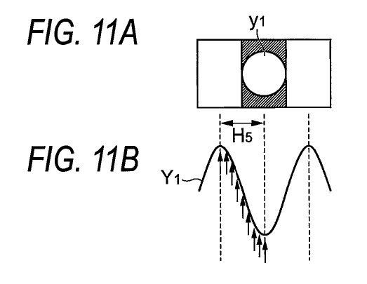

Next, description will be given below of the A/D conversion of the output voltage signal that is carried out by the A/D converting portion 63. After the light intensity is detected as the voltage signal, it is A/D converted by the A/D converting portion 63 included in the CPU 62. The A/D conversions of the output voltage signals Y₁ and Y₂, for example, as shown in FIG. 10, are carried out alternately. Since the processing contents of the A/D conversions of the output voltage signals Y₁ and Y₂ are similar to each other, in the following description, for easy understanding of the description, the A/D conversion of the output voltage signal Y₁ will be described. FIG. 11 is a general view to explain the A/D conversion of the output voltage signal Y₁. The A/D converting portion 63, as shown in FIG. 11, samples the length H₅ between two mutually adjoining extreme values while it is divided by a given number, and then A/D converts it. As the length H₅, for example, there is used 300 μm and, as the dividing number, for example, there is used 60.

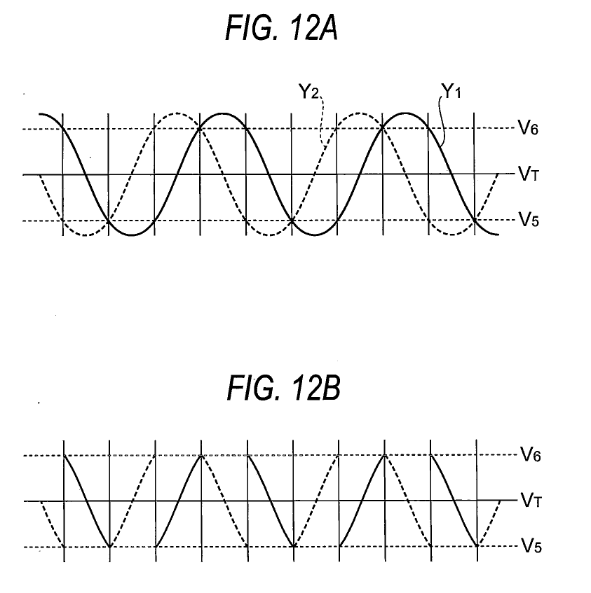

Next, description will be given below of the signal selecting unit of the image pickup apparatus. The controller 81 has the function to select an output voltage signal to be used to obtain the position information of the moving lens 90 from the output voltage signals Y₁ and Y₂ that have been A/D converted by the A/D converting portion 63. For example, the controller 81 has the function to select the output voltage signal Y₂ when the signal value of the output voltage signal Y₂ obtained at a given position is equal to or larger than a first check voltage and when such signal value is equal to or smaller than a second check voltage. On the other hand, the controller 81 has the function to select the output voltage signal Y₁ when the signal value of the output voltage signal Y₂ obtained at a given position is smaller than the first check voltage, or when such signal value is larger than a second check voltage. Here, as the first and second check voltages, in order that the waveform portions of the output voltage signals Y₁ and Y₂ in the neighborhood of the extreme values where the varying amounts of the signal values of the output signals Y₁ and Y₂ decrease will not be contained in the position detect signals, for example, there are used signal values where the periodic waveforms of the output signals Y₁ and Y₂ having a constant amplitude start to become gentle. For example, there may be set signal values where the absolute values of the inclining angles of the output signals Y₁ and Y₂ are equal to or smaller than a given value. Owing to this function, for example, as shown in FIG. 12(A), when there are obtained the output signals Y₁ and Y₂ 90 degrees out of phase, the controller 81 checks whether the signal value of the output signals Y₂ obtained at a given position is equal to or larger than a first check voltage V₅ and is equal to or smaller than a second check voltage V₆, or not. And, when the above conditional equation is affirmed, the controller 81 selects the output voltage signal Y₂; and, when the conditional equation is denied, the controller 81 selects the output voltage signal Y₁ (first check voltage V₅<second check voltage V₆). That is, at a position where the absolute value of the inclination of one output voltage signal, by selecting the other output voltage signal, the position may be specified using an output voltage signal having a large varying amount with respect to the moving amount of the moving lens 90 over the whole detect area. The two output signals Y₁ and Y₂ depending on the moving positions of the moving lens 90 shown in FIG. 12(A), as shown in FIG. 12(B), are switched by the above function to such output signals Y₁ and Y₂ as may be used for detection of the positions of the moving lens 90 according to the moving positions of the moving lens 90, whereby they are turned to an output voltage signal which depends on the moving positions of the moving lens 90 but is discontinuous. And, the controller 81 also has the function to obtain the position information about the moving lens 90 using such output voltage signal.

Next, description will be given below of the operation to detect the position of the moving lens 90. The position detect operation is carried out by the controller 81.

Firstly, description will be given below of an operation to detect that the moving lens 90 has been made to arrive at the neighborhood of the apparatus end X₁, with reference to FIG. 6. When the moving lens 90 is driven, the element driving circuit 61, using a driving signal shown in FIG. 9, allows the light emitting portions 83d and 83e of the photo reflector 83b to output the emission lights y₁ and y₂ alternately and also allows the light receiving portion 83c to convert the intensities of the reflected lights from the reflecting plate 83a to the output voltage signals Y₁ and Y₂ respectively. When the respective signal values of the output voltage signals Y₁ and Y₂ are larger than a given threshold value V₃, the position of the moving lens 90 is detected such that it is in the neighborhood of the apparatus end X₁. As the threshold value V₃, there is used a value which is smaller than the lower limit value V_{0MIN} and larger than the voltage V₁ in the amplitude of the output voltage signal Y₁.

Next, description will be given below of an operation to check that the moving lens 90 has been made to arrive at the “wide end” (position W). When the moving lens 90 arrives at the “wide end”, the center of the white area of the reflecting plate 83a is situated at the center of the radiating area of one of the emission lights y₁ and y₂. Since a phase difference between the output voltage signals Y₁ and Y₂ is 90 degrees, the signal value of one of the output voltage voltages Y₁ and Y₂ in the “wide end” provides an extreme value, while the other provides an inflection point (center voltage V_{T}). And, when the signal value of the A/D converted output voltage signal V₂ is equal to or larger than the first check voltage V₅ and equal to or smaller than the second check voltage V₆, the controller 81 selects the output voltage signal Y₂ as an output voltage signal for indicating the information about the position of the moving lens 90; and, when not, the controller 81 selects the output voltage signal Y₁ as an output voltage signal for indicating the information about the position of the moving lens 90. In the following description, for easy understanding of the description, as shown in FIG. 12(A), it is assumed that there may be obtained such output voltage signals Y₁ and Y₂ as have a 90 degrees phase difference, and also that a value obtained by subtracting a voltage value substantially ¾ in a half amplitude from the center voltage is regarded as the first check voltage V₅, while a value obtained by adding a voltage value substantially ¾ in a half amplitude to the center voltage is regarded as the second check voltage V₆. And, description will be given below of a case where, in the “wide end”, the signal value of the output voltage signal Y₁ provides an extreme value and the signal value of the output voltage signal Y₂ provides an inflection point. In this case, since the output voltage signal Y₂ in the “wide end” is equal to or larger than the first check voltage V₅ and equal to or smaller than the second check voltage V₆, as the output voltage signal for detection of the position of the moving lens 90, there is selected the output voltage signal Y₂. Therefore, the “wide end” may be specified not by the magnitude of the output voltage signal Y₂ but by the number of the inflection points of the output voltage signal Y₂ counted with the origin as the reference thereof. Here, in the EEPROM 64 of the controller 81, the output voltage signals Y₁ and Y₂ with respect to the moving positions of the moving lens 90 have been previously measured and recorded. That is, in the EEPROM 64, there are stored the frequencies and waveform numbers of the output voltage signals Y₁ and Y₂ with the origin as the reference position together with the output voltage values thereof. As the reference position (origin), for example, there is used a position P₁ which is set in the neighborhood of the apparatus end X₁ on the “wide end” side. By referring to the output voltage signals stored in the EEPROM 64, it is possible to check to which inflection point, when counted from the position P₁ on the “wide end” side, the output voltage signal Y₂ in the “wide end” corresponds. Therefore, with the position P₁ as the reference position, a position W may be specified uniquely. For example, when, after the moving lens 90 is moved toward the “wide end” and is made to arrive at the position P₁, the moving lens 90 is then moved toward the “tele end” and the number of inflection points stored in the EEPROM 64 is detected, it is detected that the position of the moving lens 90 is in the “wide end”. Here, as shown in FIG. 6, since the signal value of an output voltage signal in the “tele end” (position T7) and the signal values of output voltage signals at the positions T1˜T6 are equivalent to the inflection point of the output voltage signal Y₂, the position of the moving lens 90 may be detected according to an operation similar to the operation to detect that the moving lens 90 has arrived at the “wide end”. And, as the reference position, there may also be used a position P₂ in the neighborhood of the apparatus end X₂ on the “tele end” side.

Next, description will be given below of an operation to detect other positions than the above-mentioned positions W, T1˜T7. These positions are specified uniquely according to the number of extreme values (or inflection points) of the output voltage signals Y₁ and Y₂ with the origin P₁ in the neighborhood of the apparatus end X₁ as the reference position and also according to the signal values of the output voltage signals Y₁ and Y₂. The controller 81, for example, after it moves the moving lens 90 toward “the wide end” and the moving lens 90 arrives in the neighborhood of the apparatus end X₁, it then moves the moving lens 90 toward the “tele end”, thereby measuring the number of extreme values (or inflection points) and the signal values of the output voltage signals Y₁ and Y₂. Here, when the signal value of the A/D converted output voltage signal Y₂ is equal to or larger than the first check voltage V₅ and equal to or smaller than the second check voltage V₆, the controller 81 selects the output voltage signal Y₂ as the output voltage signal for indicating the information about the position of the moving lens 90. When not, the controller 81 selects the output voltage signal Y₁ as the output voltage signal for indicating such position information. And, according to the number of extreme values (or inflection points) having existed from the neighborhood of the apparatus end X₁ on the “wide end” side to a measuring point and the signal value of the output voltage signal selected at this measuring point, also according to an output voltage signal with respect to the moving position of the moving lens 90 stored in the EEPROM 64, the controller 81 specifies and detects the moving position of the moving lens 90 uniquely.

As described above, the position detecting element 83 and controller 81, according to the magnitudes of the signal values of the output voltage signals Y₁ and Y₂, detect that the moving lens 90 is situated in the neighborhood of the apparatus end X₁; according to the number of extreme values (or inflection points) in the selected one of the output voltage signals Y₁ and Y₂, when counted from the neighborhood of the apparatus end X₁ (origin P₁), they detect that the moving lens 90 is situated in the “wide end”, “tele end” or the like; and, they detect the other positions of the moving lens 90 according to the number of extreme values (or inflection points) in the selected one of the output voltage signals Y₁ and Y₂, when counted from the neighborhood of the apparatus end X₁ (origin P₁) and also according to the signal value of the selected one of the output voltage signals Y₁ and Y₂, In this manner, the position of the moving lens 90 may be detected by the position detecting element 83 and controller 81.

Here, when the position of the moving lens 90 is detected according to the signal value of the output voltage signal, since the signal value of the detected output voltage signal is compared with the signal value stored in the EEPROM 64, there is a fear that, when the output voltage signal is varied due to the varying temperatures, the varying attitudes of the image pickup apparatus and the like, the accuracy of the position detection may be lowered. In view of this, the image pickup apparatus including the position detecting element 83 according to the present embodiment has the function to correct the signal value of the output voltage signal of the position detecting element 83.

For example, before the moving lens 90 is moved in the image pickup area L₂, the controller 81 moves the moving lens 90 to the neighborhood of the apparatus end X₁ and, after then, moves the moving lens 90 to the wide end. And, when moving the moving lens 90 from the neighborhood of the apparatus end X₁ to the “wide end”, the controller 81 obtains actual output voltage signals Y_{R1} and Y_{R2} between the extreme values of the output voltage signals (or between the inflection points of the output voltage signals) for the respective output voltage signals Y₁ and Y₂. That is, the controller 81 obtains the actual output voltage signals Y_{R1} and Y_{R2} in the moving area L₄. And, for example, the output voltage signals Y₁ and Y₂ stored in the EEPROM 64 are compared with the actually detected output voltage signals Y_{R1} and Y_{R2} to thereby obtain differences Δ1 and Δ2.

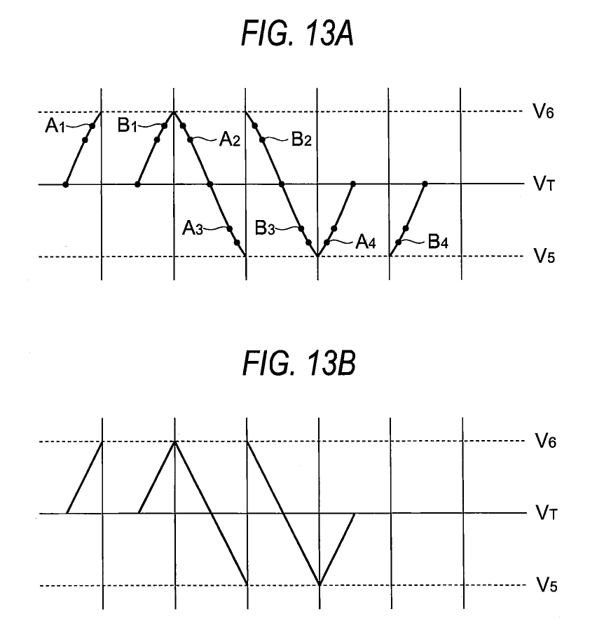

And, using the thus calculated differences Δ1 and Δ2, the controller 81 corrects the signal value of the output voltage signal that is used to detect the position of the moving lens 90. FIG. 13(A) shows output voltage signals before corrected. The controller 81, as shown in FIG. 13(A), sets given points (in FIG. 13(A), black points) of the output voltage signals as adjusting points. And, the controller 81 adds the differences Δ1 and Δ2 to the signal values of the output voltage signals at the respective adjusting points. For example, the difference Δ1 is added to the adjusting points that are designated by An (n: integer number), while the difference Δ2 is added to the adjusting points that are designated by Bn (n: integer number). Further, the respective adjusting points after corrected are connected together such that they are approximated to straight lines. FIG. 13(B) shows the output voltage signals that are obtained through the above adjustments. Owing to use of the output voltage signals shown in FIG. 13(B), even when the signal values of the output voltage signals are varied due to the varying temperatures and the like, an error caused by the varying temperatures and the like may be removed, whereby the moving position of the moving lens 90 within the image pickup area L₂ may be specified in correspondence to the signal value stored in the EEPROM 64.

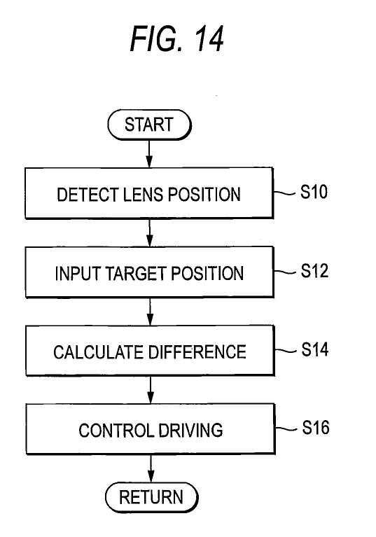

Next, description will be given below of the operation of a drive control unit for driving the actuator 10 using the position detection results. FIG. 14 is a flow chart of the operation of the image pickup apparatus including the position detecting apparatus according to the present embodiment. Processings shown in the flow chart of FIG. 14 are carried out repeatedly, for example, at the timing when the moving lens 90 is driven in the image pickup apparatus.

As shown in FIG. 14, the image pickup apparatus starts its operation in and from a lens position confirmation processing (S10). In S10, the position detecting element 83 and controller 81 detect the position of the moving lens 90. The controller 81, for example, according to the output voltage signals Y₁ and Y₂ output from the position detecting element 83, selects and adjusts one of the output voltage signals; and, after then, it compares the thus adjusted output voltage signal with the output voltage signal stored in the EEPROM 64 to thereby detect the position of the moving lens 90. When the processing in S10 is ended, the control processing moves to a target position confirming processing (S12).

In the processing in S12, for example, according to information input from a photographer or the like, a zoom amount serving as a target is input. When the processing in S12 is ended, the controller 81 moves to a difference calculating processing (S14).

In the processing in S14, a target zoom amount (a control target M) at a given time is compared with an actual moving amount S₁ at a given time to thereby obtain a difference between them. When the processing in S14 is ended, the controller 81 moves to a drive control processing (S16).

In the processing in S16, according to the difference obtained in the processing in S14, a drive signal to be output to the actuator 10 is controlled. The CPU 62, according to the difference obtained in the processing in S14, drives the drive signal. For example, when the actual moving amount S₁ is larger than the target zoom amount, in order to control the moving speed of the moving lens 90, there is executed a processing in which the driving and stopping of the actuator 10 are repeated. When the processing in S16 is ended, the control processing shown in FIG. 14 is ended.

By carrying out the control processing shown in FIG. 14 repeatedly at given timings, the actual moving amount S₁ of the moving lens 90 may be fed back in such a manner that it is allowed to approach the control target M. That is, by driving and controlling the actuator 10 while feeding back the actual moving amount of the moving lens 90 using the position detecting element 83, the moving amount S₁ along the control target M may be obtained. Also, since, by using the position detecting element 83, a driving time with respect to the moving amount may be controlled, the zoom driving operation may be executed at a constant speed.

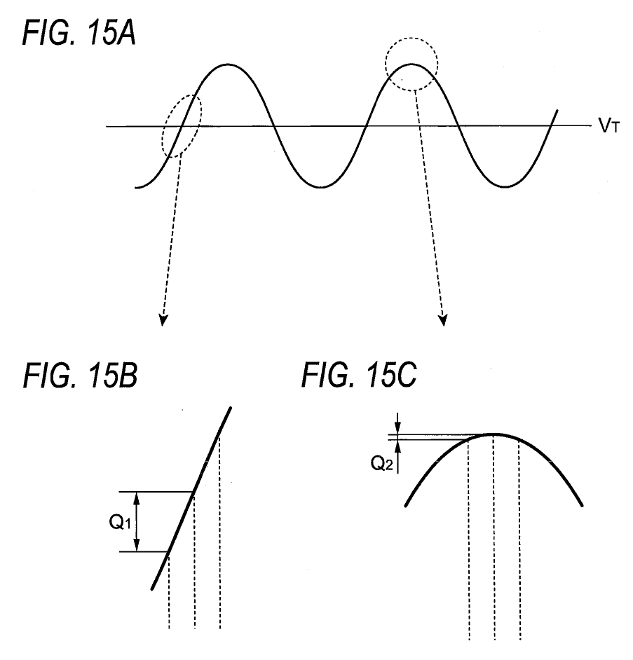

As has been described heretofore, according to the position detecting element 83 of the present embodiment, it includes the reflecting plate 83a and photo reflector 83b; and, the photo reflector 83b includes the light emitting portion 83d and light emitting portion 83e disposed parallel to the light emitting portion 83d. Also, the reflecting plate 83a is movable relative to the photo reflector 83b in the parallel arranging direction of the light emitting portion 83d and light emitting portion 83e. Owing to this structure, the position detecting element 83 allows the light emitting portion 83d and light emitting portion 83e of the photo reflector 83b to emit the lights to be detected (detection-receiving lights) y₁ and y₂ respectively to the periodic optical pattern of the reflecting plate 83a moving relative to the photo reflector 83b in such a manner that the lights y₁ and y₂ may be radiated at the different positions of the periodic optical pattern. This makes it possible for the light receiving portion 83 to obtain, for example, the two periodic output voltage signals Y₁ and Y₂ with a phase difference between them. And, since the controller 81 may select one of the two periodic output voltage signals Y₁ and Y₂ as the position detecting signal according to the signal values of the periodic output voltage signals Y₁ and Y₂, the output voltage signals, the signal values of which vary greatly with respect to the movement of the moving lens 90, may be selected at every detecting positions, and the thus selected voltage signals may be used as the position detecting signals that indicate the detected positions of the moving lens 90. For example, as shown in FIG. 15(A), it is assumed that the output voltage value has a sine wave. FIG. 15(B) is an enlarged view of the neighborhood of an inflection point shown in FIG. 15(A), and FIG. 15(C) is an enlarged view of the neighborhood of an extreme value shown in FIG. 15(A). As shown in FIG. 15(C), as the output voltage value approaches the extreme value, the varying amount Q₂ of the signal value with respect to the moving amount of the moving lens 90 decreases. Therefore, there is a fear that, when the position of the moving lens 90 is detected using the signal value in the neighborhood of the extreme value, the detection accuracy may be lowered. On the other hand, as shown in FIG. 15(B), the varying amount Q₁ of the signal value with respect to the moving amount of the moving lens 90 in the neighborhood of the inflection point is larger than the varying amount Q₂. Therefore, when multiple output voltage signals with a phase difference between them at one position are detected to select the output voltage signals that are large in the varying amount with respect to the moving amount of the moving lens 90, the position of the moving lens 90 may be detected with high accuracy. Also, since there are used the two periodic output voltage signals Y₁ and Y₂ with a phase difference between them, without delicately working the light emitting portions, optical pattern and light receiving portion, there may be obtained the position detecting signal which is large in the varying amount of the signal value thereof with respect to the moving amount of the moving lens 90. Thus, the high-accuracy position information may be obtained with a simple structure.

Also, according to the position detecting element 83 of the present embodiment, the distance H₃ between the light emitting portions 83d and 83e, the pattern width H₁ of the white area in the parallel extending direction of the light emitting portions 83d and 83e, and the pattern width H₂ of the black area in the parallel extending direction of the light emitting portions 83d and 83e may be set in such a manner that a phase difference between the output voltage signals Y₁ and Y₂ provides 90 degrees. Therefore, in the image pickup area L₂, the waveform portion of one of the output voltage signals where the varying amount of the signal value with respect to the moving amount of the moving lens 90 is small may be superimposed properly on the waveform portion of the other output voltage signal where the varying amount of the signal value with respect to the moving amount of the moving lens 90 is large. Owing to this, at every position, there may be obtained the output signal which is large in the varying amount of the signal value thereof with respect to the moving amount of the moving lens 90. Thus, the high-accuracy position information may be obtained with a simple structure.

Also, according to the position detecting element 83 of the present embodiment, when the magnitude of the output voltage signal Y₂ is equal to or larger than the first check voltage V₅ and equal to or smaller than the second check voltage V₆ larger than the first check voltage V₅, the controller 81 may select the output voltage signal Y₂ out of the two output voltage signals Y₁ and Y₂ and may use the thus selected signal Y₂ as the position detecting signal. When the magnitude of the output voltage signal Y₂ is smaller than the first check voltage V₅ or is larger than the second check voltage V₆, the controller 81 may select the output voltage signal Y₁ as the position detecting signal. Therefore, since, using the magnitude relationship between the output voltage signals and the check voltages V₅, V₆, there may be properly selected, as the position detecting signal, the output signal which is large in the varying amount of the signal value thereof with respect to the moving amount of the moving lens 90, the high-accuracy position information may be obtained with a simple structure.

Also, according to the position detecting element 83 of the present embodiment, the light emitting portions 83d and 83e may be operated in such a manner that they may emit the lights to be detected (detection-receiving lights) y₁ and y₂ alternately. Therefore, the reflected lights of the lights y₁ and y₂ emitted from the light emitting portions 83d and 83e may be received by one light receiving portion 83c separately from each other.

Further, according to the image pickup apparatus of the first embodiment of the invention, using the position detecting element 83, the information about the position of the moving lens 90 may be obtained with high accuracy using a simple structure.

### Second Embodiment

An image pickup apparatus and a position detecting element according to a second embodiment are almost similar in structure to the image pickup apparatus and position detecting element according to the first embodiment, while the second embodiment is different from the first embodiment in the function of the controller 81 to select the output voltage signal. Owing to this function, even when there is an error in the distance H₃ between the light emitting portions 83d and 83e, the degradation of the position detecting accuracy may be reduced. Here, in the second embodiment, the description of the portions thereof that are similar to those of the first embodiment is omitted, but description will be given below mainly of the different portions of the second embodiment from the first embodiment.

The controller 81 according to the second embodiment is structured almost similarly to the controller 81 described hereinabove in the first embodiment. And, when compared with the controller 81 according to the first embodiment, the controller 81 according to the second embodiment is different in that it has the following function: that is, it calculates, for every output voltage signals, check values for selecting output voltage signals to be used for position detection out of multiple output voltage signals detected at one position and, using the thus calculated multiple check values, selects output voltage signals to be used for position detection.

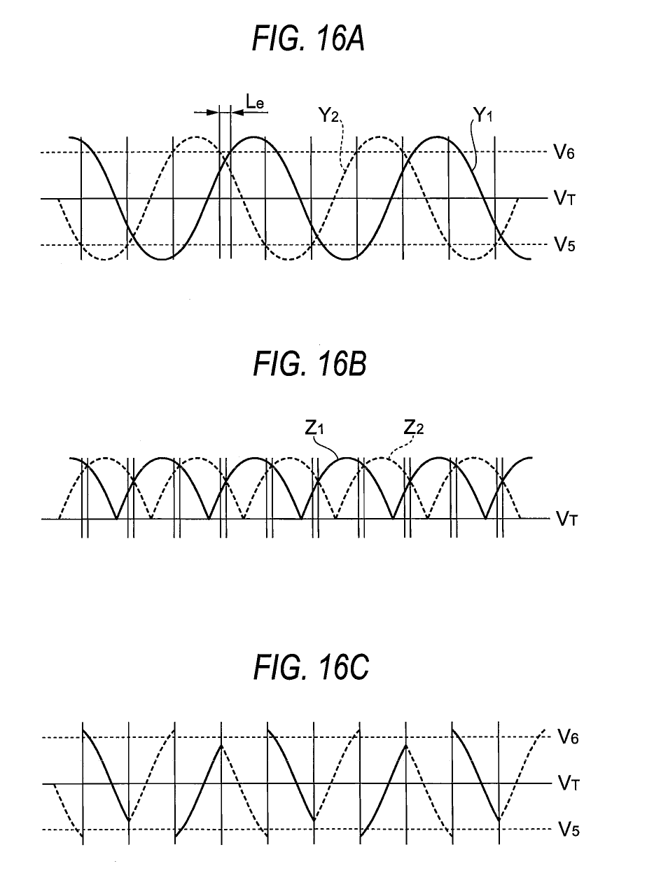

Firstly, description will be given below of the check value calculating function of the controller 81. The controller 81 has the function to calculate a difference between the center voltages V_{T} of the output voltage signals Y₁, Y₂ and the signal values of the output voltage signals Y₁, Y₂. And, the controller 81 has the function to add the absolute values of the thus calculated differences respectively to the center voltages V_{T} and use the thus added values as the check values. For example, as shown in FIG. 16(A), it is assumed that there are obtained the output voltage signals Y₁, Y₂. These output voltage signals Y₁, Y₂ are the same center voltage V_{T}. Also, a phase difference between the output voltage signals Y₁ and Y₂ is shifted by an amount of Lₑ from 90 degrees due to a difference Lₑ between the positions of the light emitting portions 83d and 83e. The controller 81 calculates a difference between the center voltages V_{T} of the output voltage signals Y₁, Y₂ shown in FIG. 16(A) and the signal values of these output voltage signals Y₁, Y₂, and then adds the thus calculated differences to the center voltage V_{T}. As a result of this, as shown in FIG. 16(B), there may be obtained check values Z₁ and Z₂ in which only the smaller signal values of the output voltage signals Y₁, Y₂ than the center voltage V are inverted with the center voltage V_{T} as the center thereof.

Next, description will be given below of the signal selecting function of the controller 81. That is, the controller 81 has a function which, using the thus obtained check values Z₁ and Z₂, selects, from multiple output voltage signals, the output voltage signals that are used to obtain information about the position of the moving lens 90. For example, the controller 81 has a function which, when a check value Z₂ obtained at a given position is equal to or smaller than the check value Z₁, selects the output voltage signal Y₂ as a position detection signal at such given position. Also, the controller 81 has a function which, when a check value Z₂ obtained at a given position is larger than the check value Z₁, selects the output voltage signal Y₁ as a position detection signal at such given position. When the output voltage signals are checked according to the check values shown in FIG. 16(B), the output voltage signals Y₁, Y₂ to be used for position detection corresponding to the moving position of the moving lens 90 are switched over to each other, whereby there may be obtained such output voltage signal as shown in FIG. 16(C). The other remaining functions of the controller 81 are similar to the first embodiment.

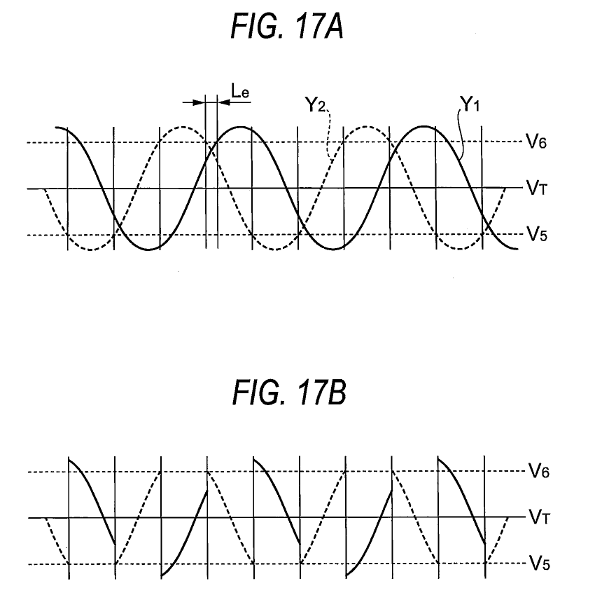

Here, as has been described in the first embodiment, when an output voltage signal to be used for position detection is selected according to the magnitude relationship between the signal values of the output voltage signals and check voltages V₅, V₆, of the output voltage signals Y₁, Y₂ shown in FIG. 17(A), the output voltage signals Y₁, Y₂ to be used for position detection are switched according to the moving positions of the moving lens 90, whereby there may be obtained such output voltage signals as shown in FIG. 17(B). However, when there exists the difference Lₑ between the positions of the light emitting portions 83d and 83e as shown in FIG. 17(A), an output signal value shown in FIG. 17(B) includes a signal value equal to or larger than the check voltage V₅ and a signal value smaller than the check voltage V₆. That is, the position detection is executed using an output voltage signal having a small varying amount with respect to the moving amount of the moving lens 90. Therefore, there is a fear that the position detecting accuracy may be degraded.

On the other hand, according to the position detecting element 83 of the second embodiment, the controller 81 adds the absolute values of differences between the center voltage V_{T} of the two amplitudes of the waveforms of the output voltage signals Y₁, Y₂ and the output voltage signals Y₁, Y₂ to the center voltage V_{T} to thereby obtain the check values Z₁, Z₂; when the check value Z₂ is equal to or smaller than the check value Z₁, the controller 81 selects the output voltage signal Y₂ as the position detecting signal; and, when the check value Z₂ is larger than the check value Z₁, the controller 81 selects the output voltage signal Y₁ as the position detecting signal. Owing to this operation of the controller 81, for example, there may be obtained such position detecting signal as shown in FIG. 16(C). The position detection signal as shown in FIG. 16(C) does not include a signal value having a small varying amount with respect to the moving amount of the moving lens 90, when compared with such output voltage signal to be used for position detection as shown in FIG. 17(B). Therefore, when compared with the position detecting element 83 according to the first embodiment, the position detecting element 83 according to the second embodiment is able to prevent a signal value having a small varying amount with respect to the moving amount of the moving lens 90 from being selected as a position detecting signal. Owing to this, for example, even when a phase difference between first and second output signals is not 90 degrees, high accurate position information may be obtained using a simple structure.

Here, the above-mentioned embodiments are just examples of an optical position detecting apparatus and an optical apparatus according to the invention. The optical position detecting apparatus and optical apparatus according to the invention are not limited to the optical position detecting apparatus and optical apparatus according to the above embodiments but, without changing the subject matter of the invention set forth in the respective appended patent claims, the optical position detecting apparatus and optical apparatus according to the above embodiments may also be changed or modified and they may also be applied to other uses.

For example, in the above embodiments, description has been given of a case where the invention is applied in order to detect the position of the moving lens 90 for zooming. However, the invention may also be applied in order to detect the position of the moving lens 102 for auto focusing, zoom lens unit portion 16 and the like. Also, the invention may also be applied in order to detect the position of other objects (for example, a stage and a probe) than the moving lens 90 when they are moved. Further, the invention may also be applied to detect the position of a shake correcting mechanism or the like when it is driven in a direction perpendicular to an optical axis.

Also, in the above embodiment, description has been given of an example where the invention is suitably employed as an optical apparatus in an image pickup apparatus. However, the invention may also be employed in a print head of an ink jet type.

Also, in the above embodiment, description has been given of an example where the piezoelectric element 1 is mounted through the support member 5 on the fixed frame 4 and the end portion of the piezoelectric element 1 is formed as a free end. However, the end portion of the piezoelectric element 1 may also be directly mounted on the fixed frame 4.

Also, in the above embodiment, description has been given of an example where, as the position detecting element 83, there are used the reflecting plate 83a and photo reflector 83b. However, it is also possible to employ a structure which includes a scale having optical pattern widths of different transmittances like a slit member, and a photo reflector.

Also, in the above embodiment, description has been given of an example where, after the A/D converting portion 63 A/D converts the output voltage signals Y₁ and Y₂, the controller 81 selects the output voltage signal to be used for position detection. However, before the A/D converting portion 63 A/D converts the output voltage signals Y₁ and Y₂, the controller 81 may select, from the output voltage signals Y₁ and Y₂, the output voltage signal to be used for position detection.

Further, although, in the above embodiments, there is employed a structure which uses the piezoelectric element as the actuator of the image pickup apparatus, it is also possible to employ other driving part such as a motor, a high polymer actuator, and a shape-memory alloy.

What is claimed is:

1. An optical position detecting apparatus comprising:
a first light emitting portion which emits a first detection-receiving light;
a second light emitting portion which is arranged parallel to the first light emitting portion, and which emits a second detection-receiving light;
an optical scale which is movable relative to the first and second light emitting portions along a parallel arranging direction of the first and second light emitting portions, the optical scale including an optical pattern containing first and second areas disposed alternately, the second area having different transmittance or reflectance from the first area with respect to the first and second detection-receiving lights;
a light receiving portion which outputs a first output signal according to a light intensity of the first detection-receiving light transmitted through the optical scale or a light intensity of the first detection-receiving light reflected by the optical scale, and which outputs a second output signal according to a light intensity of the second detection-receiving light transmitted through the optical scale or a light intensity of the second detection-receiving light reflected by the optical scale;
a signal selecting unit, according to a magnitude of one of the first and second output signals, which selects one of the first and second output signals as a position detecting signal; and,
a position information obtaining unit, according to the position detecting signal, which obtains position information of a moving member which works with the optical scale.

2. The optical position detecting apparatus according to claim 1, wherein a distance between the first and second light emitting portions as well as a pattern width made of the first area and a pattern width made of the second area respectively in the parallel arranged direction are set such that a phase difference between the first and second output signals provides 90 degrees.

3. The optical position detecting apparatus according to claim 1, wherein when the magnitude of the first output signal is equal to or larger than a first given value and is equal to or smaller than a second given value larger than the first given value, the signal selecting unit selects the first output signal as the position detecting signal, and
when the magnitude of the first output signal is smaller than the first given value or is larger than the second given value, the signal selecting unit selects the second output signal as the position detecting signal.

4. An optical position detecting apparatus according to claim 1, wherein the signal selecting unit regards an absolute value of a difference between a center value of an amplitude of a waveform of the first output signal and the magnitude of the first output signal as a first check value, and regards an absolute value of a difference between a center value of an amplitude of a waveform of the second output signal and the magnitude of the second output signal as a second check value, and
wherein when the first check value is equal to or smaller than the second check value, the signal selecting unit selects the first output signal as the position detecting signal, and
when the magnitude of the first check value is larger than the second check value, the signal selecting unit selects the second output signal as the position detecting signal.

5. The optical position detecting apparatus according to claim 1, wherein the first and second light emitting portions are operated so as to emit the first and second detection-receiving lights alternately.

6. An optical apparatus comprising:
an optical position detecting apparatus according to claim 1;
an optical member disposed so as to work with the moving member; and,
a driving source which drives the moving member and the optical member.
